(19) United States
(12) Patent Application Publication
(10) Pub. No.: US 2004/0267777 A1
(43) Pub. Date: Dec. 30, 2004

(54) File management method, recording apparatus, reproducing apparatus, and recording medium

(76) Inventors: Naozumi Sugimura, Yokohama (JP); Taku Hoshizawa, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/671,594

(22) Filed: Sep. 29, 2003

(30) Foreign Application Priority Data
Jun. 19, 2003 (JP) 2003-174229

(51) Int. Cl. G06F 7/00

(52) U.S. Cl. 707/100

(57) ABSTRACT

There is provided a sub file area which records sub file management information and a sub file. The sub file and the sub file management information are registered as one file to main file management information. At finalization, file management information compliant with a different file system is also written. For the purpose of file management, there is provided sub file management information in addition to the main file management information. The main file management information treats a sub file and the sub file management information managing it as one file. Moreover, at finalization, file management information compliant with a different file system is also written.

### BACKGROUND OF THE INVENTION

1. Field of the Invention

The present invention relates to a technology of recording or reproducing information on a recording medium and more particularly to a technology of recording or reproducing audiovisual information on a rewritable recording medium.

2. Description of the Prior Art

Data is recorded as files on recording media for optical disc apparatuses or magnetic disc apparatuses in order to enable easy access to recorded data files. In such a case, a file management system (or simply referred to as a file system) is used to manage data files.

Examples of widely available recording media include CD-ROM. The CD-ROM technology generally uses the file management system called ISO-9660. The ISO-9660 system uses tables called path tables to describe the directory structure. The path tables are sequentially numbered and are assigned 16-bit values.

On the other hand, the file system called UDF (Universal Disk Format) is used for DVDs that are becoming increasingly widespread as higher density recording media. The UDF uses tables, i.e., a file identifier and a file entry for each directory to describe the directory structure.

Reproducing apparatuses for DVD-ROM use a bridge file system for files to ensure compatibility between ISO-9660 and UDF.

In recent years, there is proposed a file management system that is used for recording and reproducing audiovisual data (hereafter referred to as AV data) and records management information including defective sectors and unused sectors at two or more locations in a logical volume. This file system uses a data management table such as a file table for file management and assigns a 16-bit number to the table for table management (e.g., refer to Japanese Unexamined Patent Application Publication No. Hei 11-312378).

The conventional file management system has the following problems.

Many conventional file management systems use 16-bit values ranging from 0 to 65535 to number tables used for the file management. Accordingly, only up to 65536 tables can be created. There has been a problem of limiting the number of files or directories capable of being managed by the file system to 65536.

On the other hand, recording media such as optical discs and magnetic discs are steadily increasing storage capacities year after year. The number of files to be recorded is also increasing.

In spite of such a trend, widespread file management systems follow the conventional technology, causing problems in the use of large capacity discs.

The use of UDF places no limitations on the number of tables and makes it possible to use many files. All the devices do not support the UDF.

Changing the file system structure nullifies the compatibility with conventional devices. Drastically changing the file system itself causes a problem. It is particularly difficult to change the software on AV (audiovisual) devices such as video disc recorders. It is impossible to reproduce discs incompatible with the conventional file system.

A PC needs to handle many small-sized files. Recording media such as optical discs generally use relatively large rewritable units. When small files are recorded, recording areas may be used wastefully.

### SUMMARY OF THE INVENTION

It is therefore an object of the present invention to provide a new file system capable of managing as many files as possible by maintaining the compatibility with conventional file systems.

If such a new file is provided, there has been a problem that no data access is available on devices only compliant with the conventional file system such as UDF.

It is another object of the present invention to provide the abovementioned new file system. It is still another object of the present invention to provide a recording method and medium capable of reading on devices that use the conventional file system such as UDF.

The file management method according to the present invention provides a conventional file system with additional file management information and treats second file management information and a plurality of files managed by the second file management information as one file on first file management information.

### BRIEF DESCRIPTION OF THE DRAWINGS

FIG. 1 shows how to describe file management information;

FIG. 2 shows a data unit structure of sector data;

FIG. 3 shows a data unit structure in an ECC block;

FIG. 4 shows a structure of main file management information;

FIG. 5 shows a configuration of sub file management information;

FIG. 6 is a block diagram of a recording and reproducing apparatus;

FIG. 7 shows how to add sub files;

FIG. 8 shows a configuration of sub file management information;

FIG. 9 shows a configuration of sub file management information;

FIG. 10 shows a configuration of sub file management information;

FIG. 11 shows how to add sub files;

FIG. 12 shows how to record file management information compliant with a plurality of file systems;

FIG. 13 shows a procedure to read files in a device compliant with the main file management information;

FIG. 14 shows a procedure to read files in a device compliant with the first file system;

FIG. 15 shows a procedure to read files in a device compliant with the second file system; and

FIG. 16 shows how to record file management information compliant with a plurality of file systems.

### DETAILED DESCRIPTION OF THE PREFERRED EMBODIMENTS

Embodiments of the present invention will be described in further detail with reference to the accompanying drawings.

The embodiment uses a bridge file system between the UDF and AV file systems. The bridge file system writes a plurality of pieces of file management information in order to ensure compatibility with old file systems. For example, a CD-R disc normally uses the UDF. Upon completion of writing, the bridge file system writes the ISO-9660 file system for finalization. This enables the same file system as for CD-ROM discs, allowing earlier versions of PCs to read discs. Since the ISO-9660 file system is incapable of writing, the UDF is required for using CD-R discs. After the finalization, no writing is available thereafter. However, this method excels in compatibility with CD-ROM discs.

The present invention uses a configuration making up a “first file system” and a “sub file system” during writing, and converts the configuration into the UDF system at the finalization.

The UDF file system has been developed for recording media including DVDs and provides high versatility capable of PC uses. In recent years, it has become general to support the UDF file system on operating systems. Since the bridge file system enables an access to large-capacity recording media from the UDF file system, the use of the UDF file system makes it possible to record and reproduce large-capacity files or many files from PCs. In addition, it is possible to record and reproduce AV data from video recorders for household use as conventionally practiced.

The embodiment assumes an optical disc to be the recording medium. However, the present invention is not limited to optical discs and can be applied to the other recording media capable of recording information such as magnetic optical discs including MDs, magnetic discs, semiconductor memory, and hard disks.

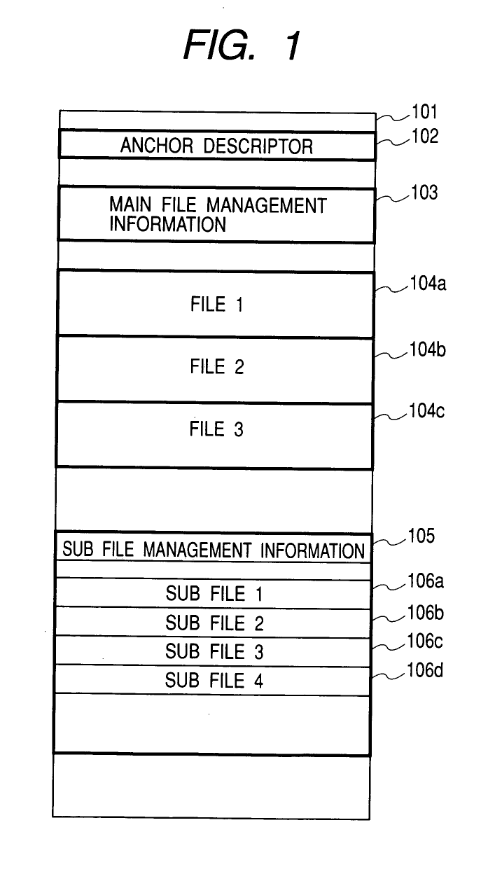

FIG. 1 shows arrangement of file management information and files on an optical disc according to the present invention.

In FIG. 1, the reference numeral 101 represents a recording area on the optical disc; 102 represents an anchor descriptor; 103 represents main file management information; 104 represents a file managed by the main file management information; 105 represents sub file management information; and 106 represents a sub file managed by the sub file management information.

This example uses three files managed by the main file management information and four sub files managed by the sub file management information.

The optical disc's recording area 101 is structured to be a sector having a specified length. Each sector can record 2048 bytes of data. Sectors are assigned sequential sector numbers from the disc center. Each sector number can be used to specify a sector to be accessed.

The anchor descriptor points to an area that records the main file management information. When the main file management area is relocated, rewriting the anchor descriptor can change the position to read the main file management area. A plurality of anchor descriptors may be recorded in an anchor descriptor recording area. In such a case, it is possible to reduce the number of rewrite operations in the anchor descriptor recording area by defining reference to only the last anchor descriptor. This also makes it possible to easily comply with the so-called write once recording system.

When a sub file system is used, it may be configured to be the same as the UDF. In this case, attaching the UDF's anchor information to the end of the sub file system makes it possible to assume as if the sub file system were recorded in the UDF.

The main file management information uses an area that manages information such as positions of data files recorded on the optical disc, data sizes, and file identifiers (file names).

A data file is recorded by a user.

The sub file management information uses an area that manages information about sub files. A set of the sub file management information and the sub file is treated as one main file on the main file system.

Data recorded on the disc needs to be correctly reproduced even if the disc is scratched or contaminated. Besides data, error detection and correction codes are added so as to enable error detection and correction, and then data is recorded on the disc. For this purpose, each sector data is converted into the form of unit data. The error correction code is added to a set of pieces of unit data.

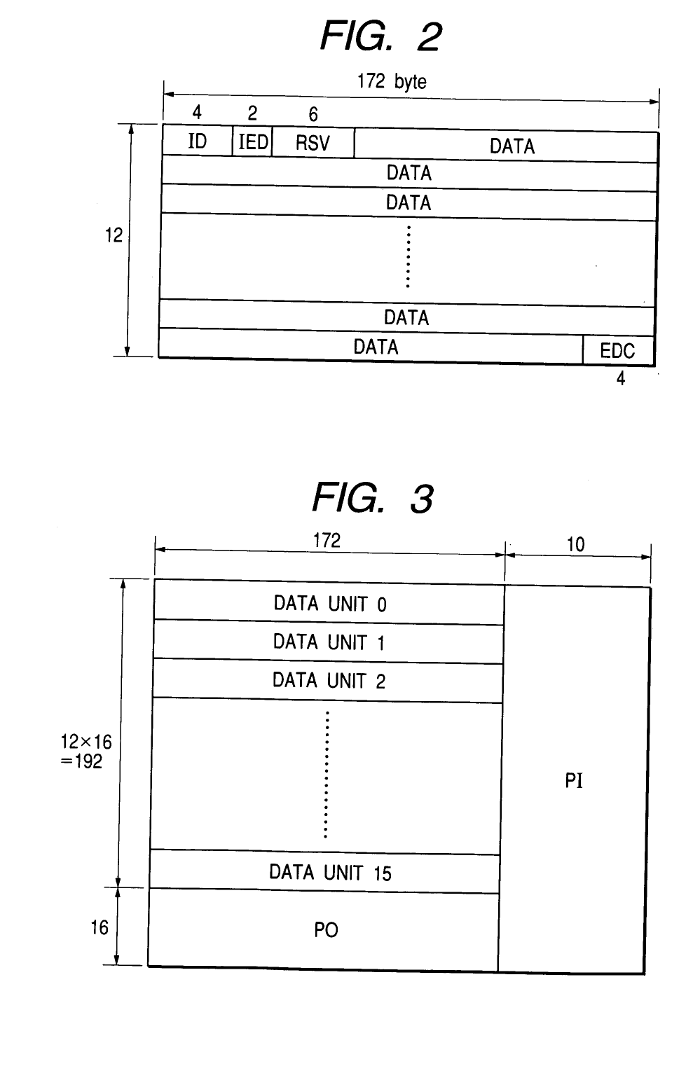

FIG. 2 shows how to configure the unit data.

Each sector uses a 2048-byte data area. Sector data is recorded in this area. The sector data is prefixed by: a 4-byte data identify code (ID) to identify data; a 2-byte IED (ID Error Detection code) as an error detection code for the ID; and a 6-byte RSV as a reserved data area. The end of recording data is suffixed by a 4-byte error detection code EDC to detect data errors. In this manner, the data unit is configured as 2064-byte data in total. Each unit data piece is handled on a row basis. There are 12 rows each making up 172 bytes.

FIG. 3 shows how to configure an ECC block.

As shown in FIG. 2, unit data is configured to makes up 12 rows each formed of 172 bytes. The unit data is collected for 16 sectors to configure an ECC block. Along a column direction, there is provided a 16-byte error correction code (PO) for each row. Each row of the ECC block makes up 208 rows in total, i.e., 192 rows of data (12 rows times 16 units) and 16 bytes of the error correction code.

Each column of data is provided with a 10-byte error correction code (PI) to configure 182-byte data. In this manner, the ECC block is recorded as 208 182-byte rows of data on an optical disc.

The CRC code (cyclic redundancy code) may be used to detect errors. The Reed-Solomon code (RS code) may be used to correct errors.

The abovementioned processes can ensure correct reproduction of data recorded on an optical disc even if the optical disc contains unreadable data due to scratch or contamination after recording and reproducing data on the optical disk.

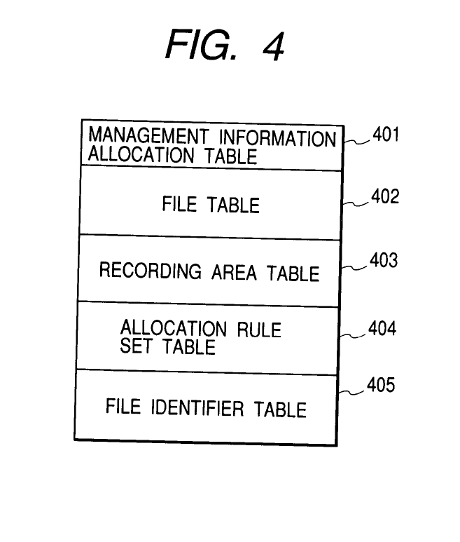

FIG. 4 diagrams the main file management information in detail.

In FIG. 4, the reference numeral 401 represents a management information allocation table; 402 represents a file table; 403 represents a recording area table; 404 represents an allocation rule set table; and 405 represents a file identifier table.

The management information allocation table 401 records allocation information about each table in the file management information. More specifically, the allocation information contains a recording start number of each table, availability of a concatenation table from the table number, or a concatenation table number. It is possible to reference the contents of each table from the area allocation information.

The file table 402 contains information such as: a file identifier table number corresponding to the file; link information indicating the directory relationship; a file attribute; a number assigned to an extended attribute information table; a file type; a file creation time; and a file modification time. Referencing the file table makes it possible to find the number of a table corresponding to each file.

The recording area table 403 records information about a recording position of each file on the disc. More specifically, the information contains a recording start sector number for the file, a recording start position, a recording end sector number, and a recording end position. When the contents of file data are read, the recording area table is referenced to find the number of a sector where the file data is recorded.

The allocation rule set table 404 records the information about division of data allocated on a disc. This information specifies a minimum division size of data recorded on the disc so that the data can be read successively. When the apparatus uses 4096 consecutive sectors (8 MB) as a unit, a parameter is set to 4096.

The file identifier table 405 maintains a name and a length of the file identifier. Let us assume one identifier table to be 32 bytes. When the file identifier length is allocated four bytes, it is possible to allocate a 28-byte data area to the file identifier itself.

Each of the abovementioned tables makes up 32 bytes. If the area becomes insufficient for recording, a plurality of tables can be used to increase the data length for recording.

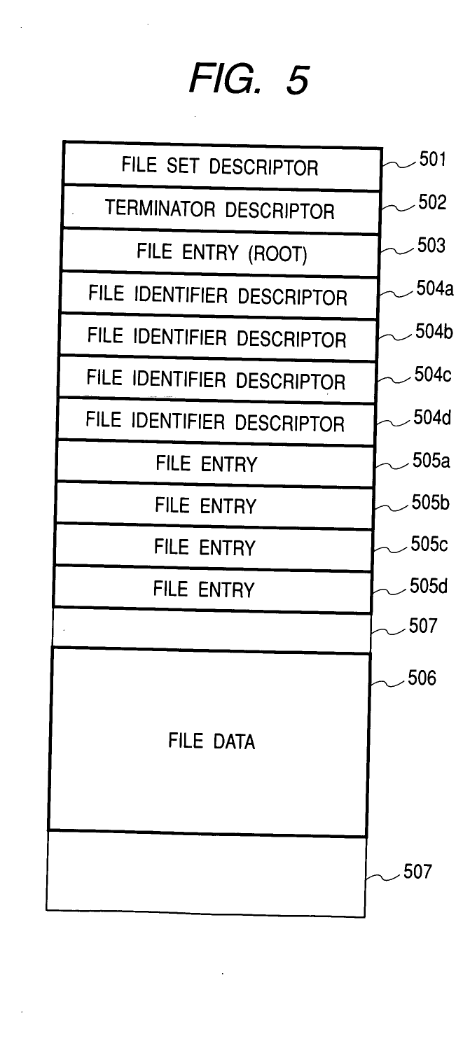

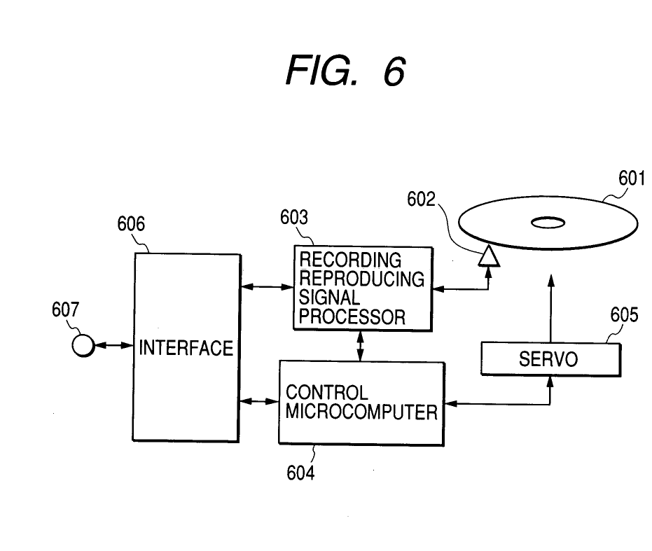

FIG. 5 shows the details of the sub file area.

In FIG. 5, the reference numeral 501 represents a file set descriptor; 502 represents a terminator descriptor; 503 represents a file entry of the root directory; 504 represents a file identifier descriptor; 505 represents a file entry; 506 represents file data; and 507 represents a free area.

Here, the reference numerals 501 through 501 correspond to the sub file management information. The file data 506 records data for a plurality of sub files.

The file set descriptor 501 records detailed information about the file system. The file set descriptor 501 can be used to obtain detailed information about the sub file system. Further, the file set descriptor 501 records information about the number of a sector that stores the root file entry 503. When the sub file system is referenced, the file set descriptor 501 is first referenced to determine the position to write the root file entry 503.

The terminator descriptor 502 indicates that no file set descriptor follows subsequently.

The root file entry 503 is a file entry that describes the root directory. The root file entry 503 describes detailed information about the root directory and the first sector number of a file identifier descriptor for a file belonging thereto.

The file identifier descriptor 504 describes names of files in the sub file system and sector numbers for file entries of the files. A file identifier recording area for each directory records file identifier descriptors for the number of files belonging to the directory.

The file entry 505 contains information such as each file attribute, a recording start sector number, a data length, and a recording time.

During a file access, the file entry 505 to be accessed is referenced from the file identifier descriptor 504 in the corresponding directory. The file's sector number recorded in the file entry is used to access the corresponding file.

The sub file area makes up a sub file 106 recorded as mentioned above and sub file management information 105 to manage the sub file. A recording area that describes the sub file management information and the sub file is allocated like a single file to the main file management information. The main file management information 103 manages the sub file management information and the sub file as one file.

The number of sub file areas is not limited to one. There may be two or more sub file areas. In such a case, a second anchor descriptor may be used to point to all the sub file management information.

FIG. 6 is a block diagram of a recording apparatus according to the present invention.

In FIG. 6, the reference numeral 601 represents an optical disc; 602 represents an optical head; 603 represents a signal processing circuit; 604 represents a control microcomputer; 605 represents a servo; 606 represents an interface; and 607 represents an input/output terminal.

The optical head 602 reads information recorded on the optical disc 601. The signal processing circuit 603 demodulates the read information. The demodulated data is subject to decoding such as error correction and is output as sector data to an external PC (not shown) via the interface 606 and the input/output terminal 607. The control microcomputer 604 accepts a command from an external host PC, for example, and controls the entire apparatus so as to access a specified sector.

During recording, the external host PC or the like inputs sector data via the input/output terminal 607 and the interface 606. The signal processing circuit 603 encodes the input data, e.g., by supplying an error correction code and modulates the data so that it can be written to an optical disc. The data is written to the optical disc 601 via the optical head 602. The control microcomputer 604 accepts commands from the external host PC and controls the entire apparatus so as to write data to the specified sector.

The servo 605 controls optical disc rotations and optical head tracking according to instructions of the control microcomputer 604.

The following describes operations for reading files on an apparatus that complies with only the main file management information, not with the sub file management information.

When the optical disc 601 is inserted into a disc drive, the control microcomputer 604 detects this event and notifies the host PC of a disc insertion via the interface 606 and the input/output terminal 607.

The host PC receives the notification about the disk insertion and first issues an instruction to read the anchor descriptor 102. The anchor descriptor 102 records the number of the sector that contains the main file management information 103.

Based on the read anchor descriptor 102, the host PC finds the sector number corresponding to the recorded main file management information 103 to read the main file management information.

The main file management information 103 records all the information about the main file such as the identifier of the main file, the recording position, and the directory structure. This information is recorded as a table.

When the main file management information is used to read a specified file, the apparatus first reads the management information allocation table 401. The apparatus retrieves all file tables 402 for the recorded files from the data in the management information allocation table. Each file table 402 contains the number of a file identifier table corresponding to the file table. Accordingly, the apparatus retrieves a file table having the file identifier table that matches the file name to be read. At this time, the apparatus also analyzes the directory based on the directory structure information written in the file table to find an intended file table.

After retrieving the file table 402, the apparatus obtains information such as the number of a sector recording the file to be read and the number of recorded bytes from the recording area information in the recording area table 403 corresponding to the retrieved file table. Based on this information, the apparatus reads data from the optical disc information sector.

The data 105 and 106 managed by the sub file system are recorded in a specific file format. That is to say, data managed in the sub file system is given a name by assuming the data to be one file. The apparatus records information about the recording position and the data length. The following describes the example here using a file name “SUBFILES.SYS”.

The main file management information 103 is treated as if it contained the file “SUBFILES.SYS” in addition to files managed by the main file system. This file name is used as a file identifier that is not normally used in the main file system. Of course, this file identifier may be named otherwise. However, the file name to be used must be unique across the main file system.

Normally, no access to SUBFILES.SYS occurs on a device compliant with only the main file management information 103. Accordingly, there occurs no access to the sub file area. As a result, there are no possibilities of inadvertent access or deletion of data, causing no adverse effect on the main file system. Even a device only compliant with the main file management information can access files other than SUBFILES.SYS as usual.

The sub file 106 and the sub file management information 105 are recorded independently of the main file system and have no effects on data in the main file system.

Let us consider that a device compliant with the main file management information may access data managed by the sub file management information. If any inconvenience occurs in this case, the SUBFILES.SYS file may be provided with attribute information such as “write inhibit”, “read inhibit”, and “hidden file” according to need. Since the SUBFILES.SYS file is a special file having the sub file system, it may be preferable to add a flag denoting this to the attribute information. These pieces of attribute information are allocated to a specified area in the file table 402. Obviously, there can be various methods such as storing the SUBFILES.SYS file in a special directory.

The file management system according to an embodiment of the present invention has been described with the abovementioned processes including the last finalization process.

As mentioned above, the file system according to the present invention highly excels in backward compatibility with the main file system.

The following describes operations for accessing sub files on a device that is also compliant with the sub file management information.

The device compliant with the sub file system first uses the main file system to obtain information such as the recording position and the length of SUBFILES.SYS. This operation is the same as the file retrieval process for the device that is compliant with only the main file management information.

According to the example in FIG. 1, the sub file management information 105 is recorded at the beginning of the position to record SUBFILES.SYS. Consequently, data is read from the beginning of the position to record SUBFILES.SYS for analysis of the contents.

The basic information about the sub file system is first obtained from the file set descriptor 501. Further, information in the file set descriptor is used to obtain a file entry recording sector number for the root. Based on this sector number, the file entry 503 for the root is read.

The root file entry contains the position to record the file identifier descriptor of a file belonging to the root directory. This position is described with a sector number. The root file entry also contains the total number of bytes of the file identifier descriptor described therein. Based on these pieces of information, the apparatus sequentially reads file identifier descriptors from the sectors that record the file identifier descriptors.

The file identifier descriptor 504 describes the identifier (file name) of each file recorded in the sub file area. Therefore, by referencing the file identifier descriptor, it is possible to obtain the file name of a file recorded in the sub file area.

The host PC retrieves the obtained file identifier descriptor 504 matching the targeted file and references data in the corresponding file identifier descriptor. The file identifier descriptor contains not only the file's descriptor, but also the recording position of the file entry corresponding to the file identifier in terms of the sector number. The host PC detects the file identifier descriptor corresponding to the targeted file name, and then reads the file entry 505 described in the file identifier.

The host PC then obtains the sector number as recording destination of the intended file and the data length thereof from the address information in the file entry. The host PC can read data from the sector number and then read the data file recorded in the sub file area.

The abovementioned processes enable an access to files in the sub file area. All the file management information and data files are written to areas corresponding to SUBFILES.SYS and are completed in the sub file system. There is no need for accesses to the main file management information 103 in the main file system or to the main file 104. Accordingly, there are no effects on the main file system, making it possible to ensure independence of the sub file system.

The following describes processes to add a sub file to the area managed by the sub file management information.

To add a sub file to the sub file area, the apparatus first uses the main file management information 103 to find a free area on the disk and writes file data on the disk. More specifically, the apparatus just needs to read the recording area table 403 associated with all files in the main file management information and check for used areas on the disk based on that table.

A sub file can be added by adding data after the sub file area. If no free area follows the sub file area, it becomes uncontinuous. However, this causes no problem.

At this time, the sub file area size increases for the added sub file data. The increase is reflected on the main file management information as an increase in the SUBFILES.SYS file.

There may be a case where the sub file cannot be recorded on a consecutive area and is divided into a plurality of recording areas. In such a case, the sub file can be recorded in a divided manner by allocating a plurality of recording areas to the recording area table for the main file management information associated with the recording areas for SUBFILES.SYS.

If the recording area is finely divided, however, an operation to read data from the optical disc frequently changes sectors to be read, causing a seek operation to consume a long time. In order to prevent this situation, it is effective to ensure a certain capacity of recording area on the disc and consecutively write data to sectors in the area. For example, it may be preferable to allocate approximately 8 MB of capacity. The information about the data length for consecutive writing is written to the allocation rule set table 404 in the main file management information.

An access to sub files is enabled by adding information such as the recorded sub file's file name, data recording position, and data length to the file identifier table 504 and the file entry 505 in the sub file management information 105.

The abovementioned processes add files to the sub file management information. At the same time, the main file management information reflects the information about the recording area. Accordingly, no inconsistency occurs on the device that uses only the main file management information.

When sub files are deleted to decrease the sub file area size, it is possible to assume that the file size of SUBFILES.SYS has changed. Based on this assumption, rewriting the main file management information causes no inconsistency between both file systems.

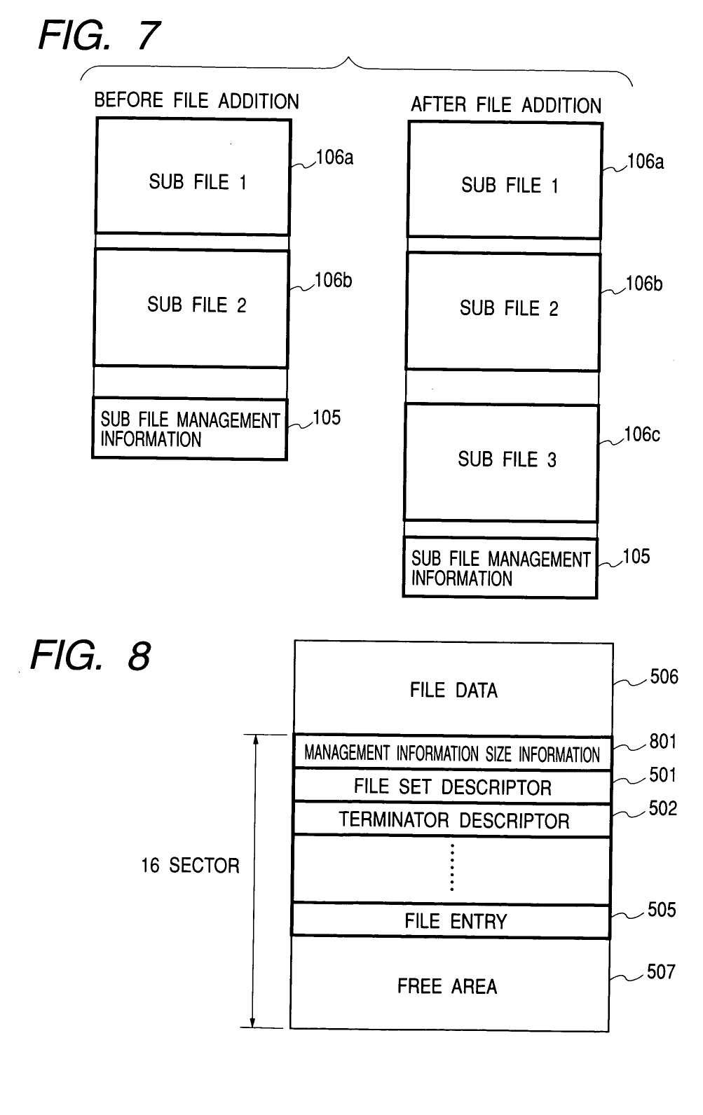

While the sub file management information is collectively recorded at the beginning of the sub file area in the abovementioned example, the present invention is not limited thereto. Various modifications may be made in such a manner as to record the sub file management information at the end of the sub file area FIG. 7 shows how to record the sub file management information at the end of the sub file area. The reference numeral 701 represents newly updated sub file management information.

According to the method of recording the sub file management information as shown in FIG. 1, the sub file management information 105 is recorded at the beginning of the sub file area. However, this method fixes the position to write the sub file management area and causes the following problems.

Since the position to write the sub file management information precedes the sub file 106, this limits the area to write the sub file management information. If many sub files are added, the area to record the sub file management information may become insufficient. Further, the sub file management information area is rewritten each time the sub file management information changes. This increases the number of operations to rewrite the area, shortening the disk life.

According to the method of recording the sub file management information as shown in FIG. 7, the sub file management information 105 is arranged after the recording area for the sub file 106. In order to add files, a file (106c) to be added is overwritten to the area where the sub file management area is written. The new file management information 701 is written after the added file. This eliminates the limitation on the area for writing the sub file management information. Since the recording area for the sub file management information changes each time a file is added, it is possible to prevent the data write operation from centering on a specific sector.

At this time, there is a possibility of failing to determine in which area the sub file management information is written. This is because there is no information about a sector to start writing the sub file management information since the main file management information 103 treats the sub file data and the sub file management information collectively as one file.

To solve this problem, the recording area for the sub file management information 105 is defined to be 16 sectors at the end of the sub file recording area, i.e., the recording area for SUBFILES.SYS. In this manner, an intended sector number can be obtained from the information in the recording area for SUBFILES.SYS. It is possible to easily find the start position of the sub file management information.

FIG. 8 shows the arrangement of data when the sub file management information is recorded in the last 16 sectors of the sub file area.

In FIG. 8, the reference numeral 801 represents management information size information.

The ECC block size is used to determine the last 16 sectors in the sub file recording area as the recording position for the sub file management information. This is based on the following reason. An error correction process is performed when sector data is read. Reading data in units of ECC blocks shortens the read time compared to a case where data is distributed to a plurality of ECC blocks. Further, the efficiency of writing highly improves if the sub file management information is written in units of ECC blocks. Of course, the recording position is not limited to 16 sectors. The sub file management is also available if the sub file management information is recorded at any position in the sub file area.

According to the method of recording the sub file management information as shown in FIG. 8, management information size information 801 is recorded at the beginning of the sub file management information. This configuration is used for easy management of the sub file management information and is not mandatory.

To access sub files, the apparatus just needs to obtain the necessary read data size from the management information size information 801 and read the sub file management information 501 through 505. After the sub file management information is read, sub files are accessed in the same manner as mentioned above.

There arises a problem when the recording position for the sub file management information is determined to be the last 16 sectors in the sub file area. More specifically, a problem occurs when the sub file management information is sized over 16 sectors. The problem is how to record the sub file management information exceeding 16 sectors.

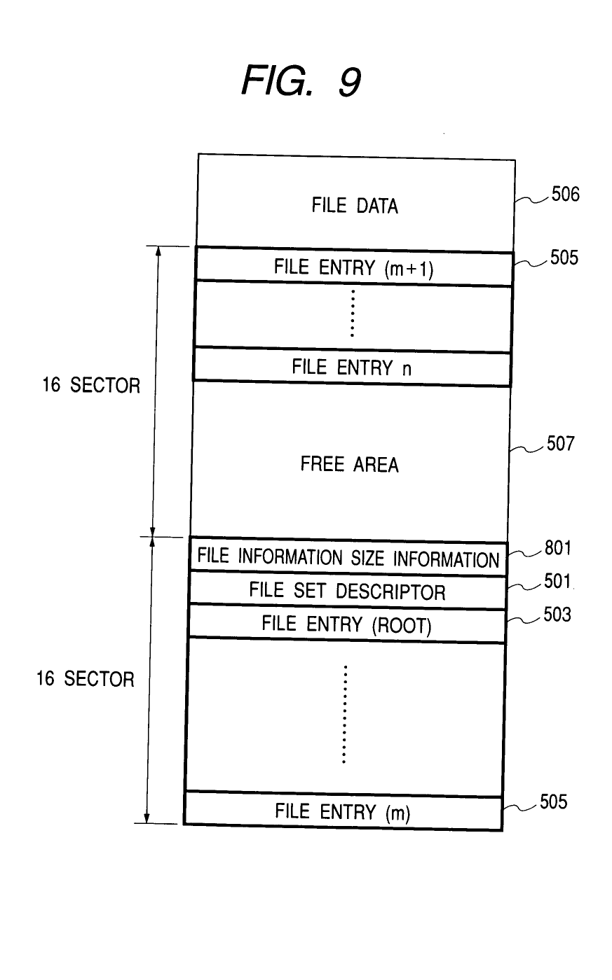

To solve this problem, the present invention uses a recording method as shown in FIG. 9.

FIG. 9 shows a method of recording the sub file management information whose size exceeds 16 sectors.

When the size of the sub file management information exceeds 16 sectors, the most recent 16 sectors are resumed to obtain the excess part of the sub file management information. When the sub file management information does not fit to 32 sectors if used, another 16 sectors is used. In this manner, the oversized sub file management information can be recorded.

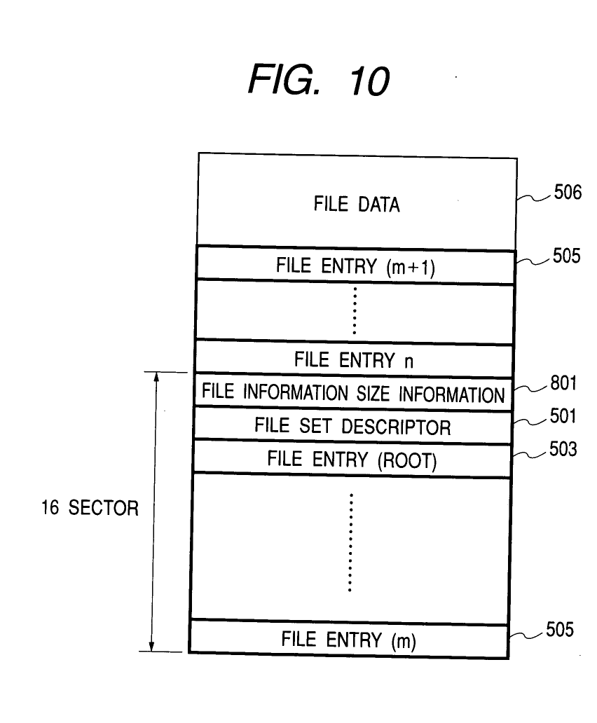

FIG. 10 shows another method of recording the sub file management information whose size exceeds 16 sectors.

The method of recording the sub file management information in FIG. 10 records the sub file management information except the first 16 sectors in the immediately preceding area.

Unlike the method in FIG. 9, the method in FIG. 10 has an advantage of providing the fast file access without needing to incrementally increase sectors even if the sub file management information is large-sized. It is possible to find the size of the sub file management information except the last 16 sectors from the management information size information.

As mentioned above, the sub file management information can be recorded at the end of the sub file recording area. Also in this case, the recording start position of the sub file management information can always be fixed to the last 16th sector in the sub file area, i.e., SUBFILES.SYS, making read operations easy. Of course, any position can be specified as the recording start position of the sub file management information.

There is another advantage of settling the recording start position of the sub file management information at the end of the sub file recording area. That is to say, additional writing is made easy on a so-called write-once optical disc that allows recording only once.

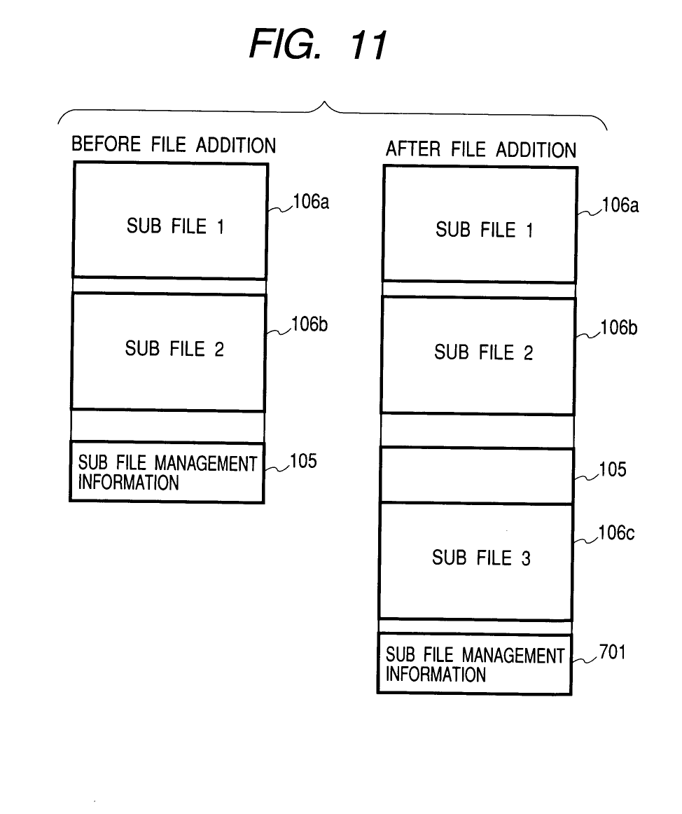

FIG. 11 shows how the sub file recording area changes after data is added to the disc.

Since data written to the write-once disc cannot be erased, rewriting data follows additional writing. Data is written in units of ECC blocks.

In FIG. 11, sub file 3 (106c), when written, is added after the old sub file management information 105. Here, the recording start position of the sub file management information is defined to be the 16th sector at the end of the sub file recording area. Consequently, the old sub file management information becomes unusable. Then, information about sub file 3 is added to the old sub file management information to create new sub file management information 701. Recording this information after sub file 3 makes it possible to automatically reference the new sub file management information.

It should be noted that the size of the sub file recording area increases. The main file management information needs to be modified as if the SUBFILES.SYS size increased.

As mentioned above, the use of the sub file system enables processes such as accessing or adding sub files. In this case, there are few effects on the main file system, causing no problems about compatibility with the conventional file system.

While the abovementioned examples have treated the sub file management information and sub files as one main file, various modification may be made. For example, it is also possible to configure the sub file management information to be an independent main file form and a sub file to be another main file. In this case, these main files are treated as two different files with respect to the main file management information. However, the same effect is provided.

It may be preferable to provide each directory for the main file with the independent sub file management information and sub files. According to this method, the main file management information is used to manage directories. It is possible to treat files belonging to the directory as sub files. The sub file management information need not manage information about the directory structure, making the configuration simple.

The abovementioned file system is compatible with AV devices such as optical disc recording and reproducing apparatuses. An AV device compliant with the conventional file system can access files recorded in the main file management information. However, a device only compliant with different file systems such as UDF cannot even read files. To enable reading on apparatuses that use different file management information other than the abovementioned file system, the file management information compliant with the second file system is written after completion of writing a file.

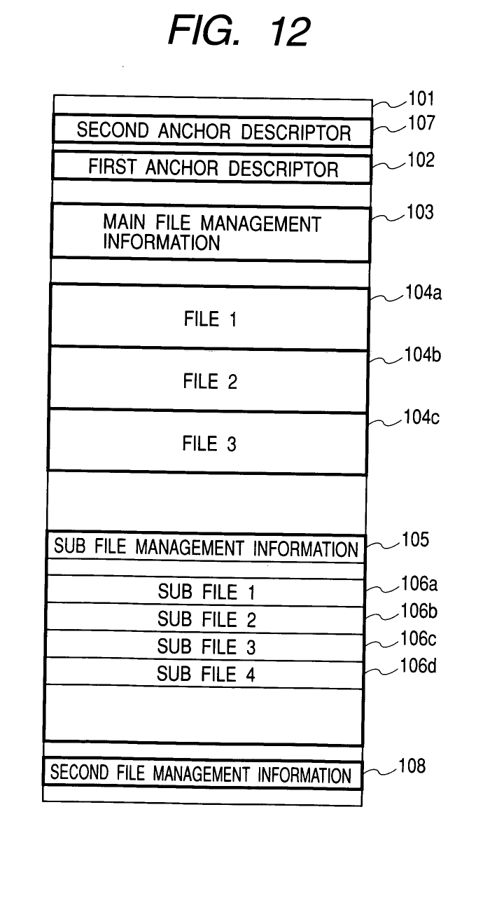

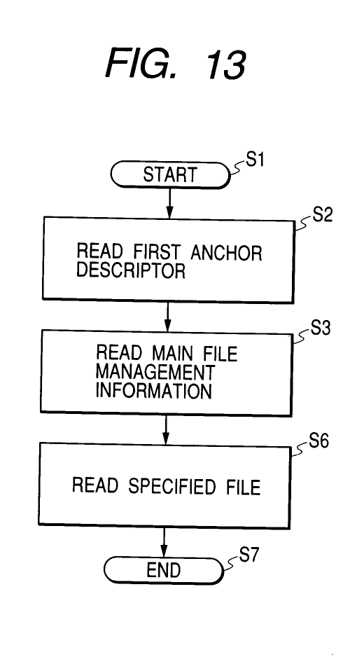

FIG. 12 shows a method of recording second file management information according to the present invention.

In FIG. 12, the reference numeral 107 represents a second anchor descriptor, and 108 represents second file management information.

A file is written in the same manner as the recording method of the file management information as shown in FIG. 1. The file management uses the main file management information 103 and the sub file management information 105. Upon completion of writing the file, a user may specify finalization of the disc. In such a case, the apparatus converts all file management information contained in the main file management information 103 and the sub file management information 105 into the second file management information compliant with the second file management system. The apparatus then records the second file management information in the free area on the disc. Further, the apparatus records the second anchor descriptor 107 compliant with the second file management system (e.g., UDF) at a specified position on the disc. The second anchor descriptor 107 contains information indicating the position of the second file management information 108.

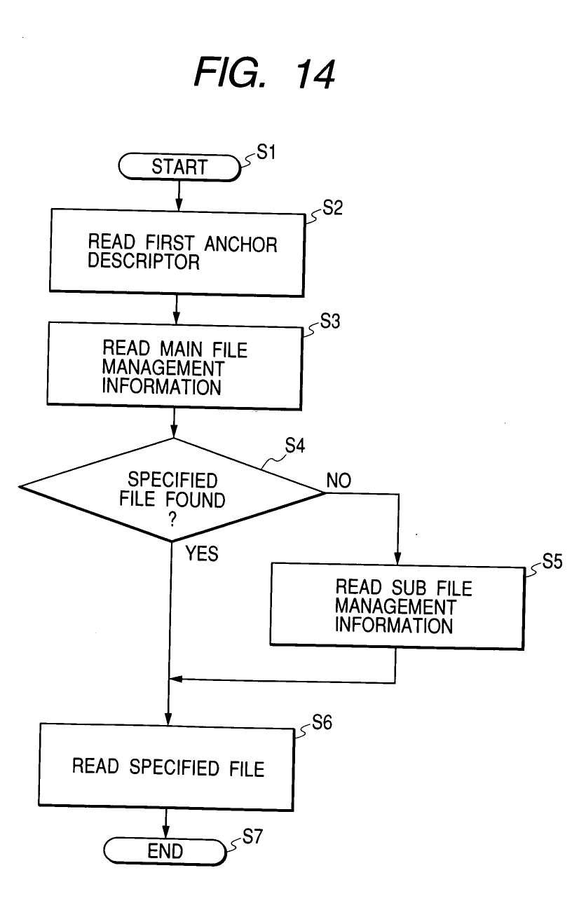

FIG. 13 shows a process of reading files on an apparatus only compliant with the main file management information 103 of the first file management information.

When the apparatus is requested to read a file from an optical disc containing the file management information having the structure as shown in FIGS. 1 through 12, the process as shown in FIG. 13 takes place. The process starts at step S1 and reads information about the first anchor descriptor at step S2 (S2). The first anchor descriptor 102 describes the information, i.e., the recording position of the main file management information 103. Based on this information, the main file management information 103 is read (S3). The process reads the recording position and the data length of a file having a specified file name from the main file management information 103 to read the specified file 104 (S6). Upon completion of reading the file, the process terminates (S7). When the specified file is not found in the main file management information 103, a specified error process is performed to obtain information notifying that the file does not exist. The abovementioned process enables reading of main files on the apparatus that complies with only the main file management information.

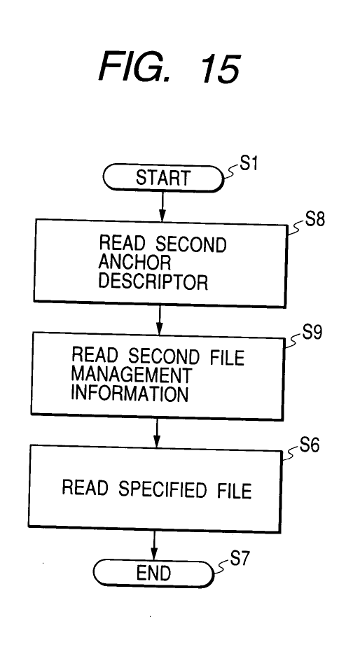

FIG. 14 shows a process of reading files on an apparatus that complies with both the main file management information 103 and the sub file management information 105 of the first file management information.

When the apparatus is requested to read a file, the process in FIG. 14 starts (S1). The process reads the first anchor descriptor 102 (S2). The process obtains the recording position of the main file management information 103 from the information in the first anchor descriptor 102 to read the main file management information 103 (S3). Then, it is determined whether or not the main file management information 103 contains the file to be read (S4). When the main file management information 103 contains the file to be read, it is possible to obtain the recording position and the data length of the specified file from the main file management information 103. The process uses the main file management information 103 to read the specified file 104 (S6).

When it is determined at step S4 that the main file management information does not contain the specified file, the process reads the sub file management information 105 (S5). The process obtains information such as the recording position and the data length of the specified file from the sub file management information 105, reads the specified file 106 (S6), and then terminates (S7). When the specified file does not exist in the main file management information 103 or the sub file management information 105, a specified error process is performed to obtain information notifying that the file does not exist. The abovementioned process enables reading of the main file 104 and the sub file 106 on the apparatus that complies with both the main file management information 103 and the sub file management information 105.

On the other hand, files are read according to a process as shown in FIG. 15 on an apparatus that complies with only the second file management information, not with the abovementioned file management method.

On an apparatus that complies with only the second file management information 108 (e.g., a UDF-compliant apparatus), the process starts (S1) and then reads the second anchor descriptor 107 (S8). The process uses information in the second anchor descriptor 107 to obtain the recording position of the second file management information 108, and then reads the second file management information 108 (S9). The process obtains the recording position and the data length of the specified file from the second file management information 108, reads the specified files 104 through 106 (S6), and then terminates (S7).

A variety of apparatuses can be used by recording a plurality of pieces of file management information as shown in FIG. 12. For example, it is possible to improve the compatibility of recorded optical discs by use of widely used file systems including the UDF as the second file management method. According to the UDF, the anchor descriptor is referred to as an anchor volume descriptor pointer.

As mentioned above, a user may specify finalization of the disc after writing the file. Thereafter, control can be provided to write the second anchor descriptor. In this manner, it is possible to prevent the second file management information from being used before the finalization. This can prevent the apparatus compliant with the second file management information from inadvertently rewriting or deleting data.

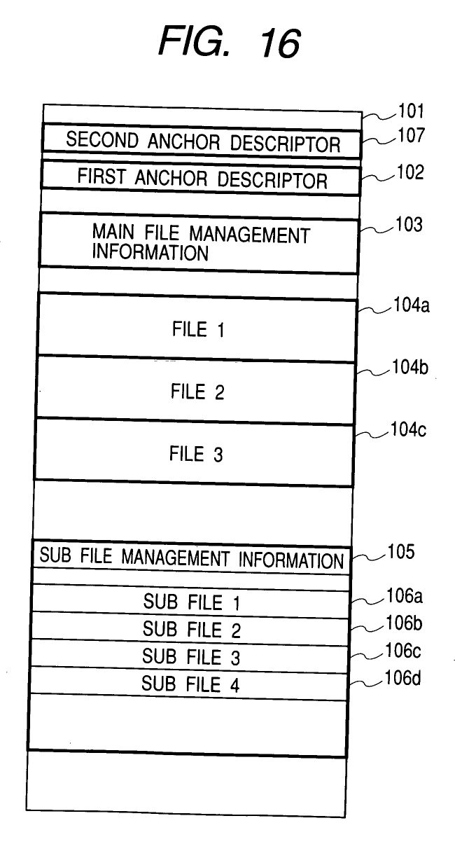

While the recording method of the file management information in FIG. 12 writes the second file management information anew, the sub file management information can also be used as the second file management information. FIG. 16 shows an example of using the sub file management information as the second file management information. In this case, the second anchor descriptor 107 records the position of the sub file management information 105 as the recording position of the file management information.

It is possible to follow the process in FIG. 15 to read files using the file management information as shown in FIG. 16. More specifically, the process starts reading the file (S1) in FIG. 15 and then reads the second anchor descriptor 107 (S8). The process reads the second file management information from the information in the second anchor descriptor (S9). Here, the sub file management information 105 is used as the second file management information. The process retrieves information about the recording position and the data length of the specified file from the sub file management information 105 and uses this information to read the specified file 106 (S6).

As mentioned above, the sub file management information 105 is used as the second file management information. This eliminates the need for adding the file management information anew, making it possible to effectively use recording areas on the disc.

Since the embodiment uses the sub file management information as well as the main file management information, it is possible to manage more files than those in the case where only the main file management information is used. Further, the sub file system is treated as one file on the main file system. Accordingly, the present invention has no effects on the main file system structure and highly excels in the compatibility.

Moreover, if there are many small-sized files as sub files, these files are treated as one file. It is possible to effectively use recording areas.

What is claimed is:

1. A file management method of managing file format data recorded on a recording medium, comprising the steps of:
having at least two different pieces of file management information;
treating second file management information as a file on first file management information;
previously recording a first anchor descriptor indicative of a recording position of the first file management information; and
recording a second anchor descriptor indicative of a recording position of the second file management information after file update.

2. The file management method according to claim 1,
wherein there is provided file attribute information on the first file management information where the second file management information is recorded, and the attribute information is appended by an attribute signifying that the file is file management information.

3. The file management method according to claim 1,
wherein a predetermined specific file name is attached to a file for the first file management information where the second file management information is recorded.

4. A file management method of managing file format data recorded on a recording medium, comprising the steps of:
having at least two different pieces of file management information;
treating a plurality of files managed by second file management information as one file on first file management information;
previously recording a first anchor descriptor indicative of a recording position of the first file management information; and
recording a second anchor descriptor indicative of a recording position of the second file management information after file update.

5. The file management method according to claim 4,
wherein there is provided file attribute information on the first file management information which handles the plurality of files managed by the second file management information, and the attribute information is appended by an attribute signifying that the files are file management information.

6. The file management information according to claim 4
wherein a predetermined specific file name is attached to a file on the first file management information which handles the plurality of files managed by the second file management information.

7. A file management method of managing file format data recorded on a recording medium, comprising the steps of:
having at least two different pieces of file management information;
treating second file management information and a plurality of files managed by the second file management information as one file on first file management information;
previously recording a first anchor descriptor indicative of a recording position of the first file management information; and
recording a second anchor descriptor indicative of a recording position of the second file management information after file update.

8. The file management method according to claim 7,
wherein there is provided file attribute information on the first file management information which records the second file management information and the plurality of files managed by the second file management information, and the attribute information is appended by an attribute signifying that the files are file management information.

9. The file management method according to claim 7,
wherein a predetermined specific file name is attached to a file on the first file management information which records the second file management information and the plurality of files managed by the second file management information.

10. A recording apparatus to record file format data on a recording medium,
wherein file data is recorded in accordance with a file management system compliant with the file management method according to claim 1.

11. A reproducing apparatus to reproduce file format data from a recording medium,
wherein file data is reproduced from a recording medium compliant with the file management method according to claim 1.

12. A reproducing apparatus to reproduce file format data from a recording medium,
wherein, when file format data is reproduced from a recording medium compliant with the file management method according to claim 1,
the apparatus uses second file management information to access files upon successful detection of a second anchor descriptor;
and wherein the apparatus uses first file management information to access files upon unsuccessful detection of the second anchor descriptor.

13. A recording medium,
wherein the recording medium records file management information compliant with the file management method according to claim 1.
